(19) United States
(12) Patent Application Publication
(10) Pub. No.: US 2023/0013441 A1
(43) Pub. Date: Jan. 19, 2023

(54) METHOD FOR MANUFACTURING A POLYESTER CONTAINING AT LEAST ONE 1,4:3,6-DIANHYDROHEXITOL UNIT WITH REDUCED COLOURING AND IMPROVED RATES OF INCORPORATION OF THE UNIT(S)

(71) Applicant: ROQUETTE FRERES, Lestrem (FR)

(72) Inventors: René SAINT-LOUP, LOMME (FR); Nicolas JACQUEL, PONTARLIER (FR); Gabriel DEGAND, SAINT-VENANT (FR)

(21) Appl. No.: 17/757,413

(22) PCT Filed: Dec. 17, 2020
(86) PCT No.: PCT/FR2020/052520

§ 371 Date: Jun. 15, 2022

(30) Foreign Application Priority Data
Dec. 20, 2019 (FR) FR19 15172

(51) Int. Cl. C08G 63/183; C08K 3/08

(52) U.S. Cl. CPC C08G 63/183; C08K 3/08; C08K 2003/0843

(57) ABSTRACT

A method for manufacturing a polyester containing at least one 1,4:3,6-dianhydrohexitol unit, including a step of introducing, into a reactor, monomers comprising at least one monomer (A) which is a diacid or a diester and at least one monomer (B) which is a 1,4:3,6-dianhydrohexitol, a step of introducing, into the reactor, a catalytic system comprising either a catalyst comprising the element germanium and a catalyst comprising the element tin, or a catalyst comprising the elements germanium and tin or a mixture of said catalysts, a step of polymerizing the monomers to form the polyester, a step of recovering a polyester composition comprising the polyester and the catalytic system. The invention also relates to a polyester composition containing a catalytic system and the use of same to reduce the colouring of the polyester.

### TECHNICAL FIELD

The present invention relates to a method for manufacturing polyester comprising at least one 1,4:3,6-dianhydrohexitol unit, using a catalytic system to reduce the colouring of the polyester thus formed and to increase the rate of incorporation of said unit into the polyester. The invention also relates to a polyester composition comprising said catalytic system.

### BACKGROUND ART

Because of their numerous advantages, plastics have become indispensable in the mass production of objects. Indeed, because of their thermoplastic nature, all kinds of objects can be manufactured at high speed from these plastics.

Certain aromatic polyesters are thermoplastic and have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the manufacture of containers, packaging, or textiles. PET can be a transparent polymer and thus be useful for the manufacture of objects whose optical properties are important. It can also be opaque and white in the case of a semi-crystalline polymer, if the crystallinity and crystallite size are important. It is therefore necessary in both cases for the PET to have as little colouring as possible.

By “monomeric units” is meant according to the invention units included in the polyester which can be obtained after polymerisation of a monomer. With respect to the ethylene glycol and terephthalic acid units included in PET, they can either be obtained by an esterification reaction of ethylene glycol and terephthalic acid or by a transesterification reaction of ethylene glycol and terephthalic acid ester.

The development of polyesters from renewable biological resources in the near term has become an ecological and economic imperative in the face of the depletion and rising prices of fossil resources such as oil. One of the important concerns today in the field of polyesters is therefore to provide polyesters of natural origin (biosourced). This is particularly true for polyesters comprising aliphatic diol and aromatic acid units. Thus, corporations such as Danone and Coca-Cola are now marketing beverage bottles made of partially biobased PET, which is manufactured from biobased ethylene glycol. A disadvantage of this PET is that it is only partially biobased, as terephthalic acid is usually derived from fossil resources. However, methods for the synthesis of biobased terephthalic acid and biobased terephthalic acid esters have recently been developed, allowing the manufacture of fully biobased PET. For example, WO 2013/034743 A1 can be cited, which describes such PETs in particular.

However, for certain applications or under certain conditions of use, these polyesters do not have all the required properties. Thus, glycol-modified PETs (PETg) have been developed. These are generally polyesters comprising, in addition to ethylene glycol and terephthalic acid units, cyclohexanedimethanol (CHDM) units. The introduction of this diol into the PET makes it possible for it to adapt the properties to the intended application, for example to improve its impact resistance or its optical properties, especially when the PETg is amorphous.

Other modified PETs have also been developed by introducing, into the polyester, 1,4:3,6-dianhydrohexitol units, especially isosorbide (PEIT). These modified polyesters have higher glass transition temperatures than unmodified PETs or PETgs comprising CHDM. In addition, 1,4:3,6-dianhydrohexitols have the advantage of being able to be obtained from renewable resources such as starch. These modified polyesters are particularly useful for the manufacture of bottles, films, thick sheets, fibers or articles requiring high optical properties.

On the one hand, a problem with these PEITs is that they can have a generally high colouring, usually higher than PETg or PET, even when the amounts of isosorbide used in the manufacture of the polyester are very low.

In order to solve this problem of high colouring, a method for the preparation of PEIT by melt polymerisation has already been described in patent application US 2006/0173154 A1. This method comprises a first esterification step and a second polycondensation step, wherein a primary antioxidant is used in the esterification step and a secondary antioxidant is used in the polycondensation step. In the examples, a catalytic system comprising germanium-based and cobalt-based catalysts are used.

In patent applications WO2013/183873 and WO2013/183874, methods are described for making polyesters comprising an esterification step of monomers comprising terephthalic acid, CHDM, isosorbide and additional diol compounds in the presence of an esterification catalyst which is a zinc compound. This catalyst allows to improve the polymerisation reaction kinetics and/or to increase the viscosity of the polymer obtained from this method. In the methods exemplified in these two applications, a germanium-based catalyst is introduced during the polycondensation step.

The Applicant has found, by conducting research into polymerisation catalysts for the manufacture of polyesters containing 1,4:3,6-dianhydrohexitol units, that the polyesters obtained from these methods are not fully satisfactory, especially in terms of colouring. This colouring can be either very yellow, as is the case when a germanium-based polycondensation catalyst is used exclusively, or gray when a catalytic system comprising germanium and cobalt-based catalysts is used. Therefore, there is still a need to find new methods for the manufacture of polyesters containing 1,4:3,6-dianhydrohexitol units with improved colouring.

On the other hand, another problem encountered in the manufacture of polyesters comprising 1,4:3,6-dianhydrohexitol units lies in the fact that the incorporation rate of these units is not always high. A high incorporation rate of 1,4:3,6-dianhydrohexitol units is however desirable to achieve sufficient thermal and mechanical performance for various applications such as in the packaging sector.

The low incorporation can be explained by the fact that esterification reactions of isosorbide with terephthalic acid or transesterifications with alkyl terephthalates involve secondary hydroxyls and are therefore less rapid than reactions involving primary alcohols such as ethylene glycol or 1,3-propanediol. As a result, this induces insufficient incorporation of isosorbide into the copolymer.

With a view to achieving improved incorporation of isosorbide into polyesters, U.S. Pat. No. 6,737,481 describes a method involving the synthesis of a binding unit. This binding unit consists of isosorbide and diacids such as isophthalic acid and phthalic acid. The binding unit then undergoes a polycondensation step by mixing with a pre-polymer. The pre-polymer can be selected from poly(alkylene terephthalate), preferably poly(1,3-propylene terephthalate). After the polycondensation step, a preferred polymer is poly(ethylene-co-isosorbide isophthalate).

U.S. Pat. No. 6,818,730 describes a method for producing polyester comprising isosorbide, said method providing a high incorporation rate of isosorbide in the final polyester. The method describes melt blending a first polyester incorporating isosorbide with a second polyester for a sufficient time to allow a transesterification reaction to occur and thereby obtain a copolymer. The first polyester consists essentially of isosorbide unit and dicarboxylic acid unit while the second polyester consists essentially of dicarboxylic acid unit and a diol unit other than isosorbide.

A method for obtaining PEIT showing an improved incorporation rate of isosorbide up to 30% is proposed by WO2019/004679. According to the examples of the same document, when a GeO₂ germanium oxide is used, said rate is around 10%.

Therefore, there is still a need to find new methods for the manufacture of polyesters containing 1,4:3,6-dianhydrohexitol units, whose colouring and incorporation rate of 1,4:3,6-dianhydrohexitol units are improved.

### SUMMARY OF THE INVENTION

The invention improves the situation.

One object of the invention is therefore a method for manufacturing a polyester containing at least one 1,4:3,6-dianhydrohexitol unit comprising at least:
a step of introducing, into a reactor, monomers comprising at least one monomer (A) which is a diacid or a diester and at least one monomer (B) which is a 1,4:3,6-dianhydrohexitol unit;
a step of introducing into the reactor a catalytic system comprising either a catalyst comprising the element germanium and a catalyst comprising the element tin, or a catalyst comprising the elements germanium and tin, or a mixture of these catalysts;
a step of polymerizing said monomers to form the polyester;
a step of recovering a polyester composition comprising the polyester and the catalytic system.

Catalytic systems combining a germanium-based catalyst with an aluminum-based catalyst or combining a tin-based catalyst with an aluminum-based catalyst have already been described for the manufacture of PEIT-type polyesters in WO 2016/066956. In this application, the colors of a polyester obtained from a germanium-based catalyst are compared with a polyester obtained from a catalytic system comprising a germanium and aluminum-based catalyst or with a polyester obtained from a catalytic system comprising a tin and aluminum-based catalyst. If the colouring of the polyester is decreased, they still show a faint yellow colouring. Such a catalytic system does not appear to have a significant impact on the rate of incorporation of the 1,4 unit: 3,6-dianhydrohexitol unit.

Surprisingly, as demonstrated in the examples, the polyester recovered from the method according to the invention exhibits both a lower colouring than a polyester obtained from a similar method that differs in the catalytic system used and a higher incorporation rate of the 1,4:3,6-dianhydrohexitol unit.

Application WO 2018/101320 describes catalytic systems combining a germanium-based catalyst with a cobalt-based catalyst for the manufacture of PEITg-type polyesters. However, in the polyesters obtained from a catalytic system, the maximum rate of incorporation of isosorbide reached is only 14%.

According to a second aspect, there is proposed a polyester composition comprising:
a polyester containing at least one 1,4:3,6-dianhydrohexitol unit, and
a catalytic system comprising either a catalyst comprising the element germanium and a catalyst comprising the element tin, or a catalyst comprising the elements germanium and tin, or a mixture of these catalysts.

According to a third aspect, there is provided an article comprising the polyester composition according to the second aspect.

According to a fourth aspect, it is proposed to use a catalytic system comprising a catalyst comprising the element germanium and a catalyst comprising the element tin, a catalyst comprising the elements germanium and tin or a mixture of these catalysts to reduce the colouring of a polyester containing at least one 1,4:3,6-dianhydrohexitol unit.

### DETAILED DESCRIPTION OF THE INVENTION

The invention relates to a method for manufacturing a polyester containing at least one 1,4:3,6-dianhydrohexitol unit.

This method comprises a step of introducing monomers into a reactor. The monomers introduced into the reactor comprise at least one monomer (A) which is a diacid or a diester and at least one monomer (B) which is a 1,4:3,6-dianhydrohexitol unit.

By diacid or diester is meant according to the invention a carboxylic diacid or carboxylic acid diester.

According to a preferred embodiment, monomer (A) is a diacid or a mixture of diacids. Some diacids, such as phthalic acid or maleic acid, can also be present in anhydride form.

The diacid can be an aromatic diacid, an aliphatic diacid or a mixture of these diacids.

Preferably, the diacid is aromatic. It can be selected from terephthalic acid, isophthalic acid, phthalic acid, 2,6-naphthalene dicarboxylic acid, 1,4-naphthalene dicarboxylic acid, a furanedicarboxylic acid, and a mixture of these diacids. Preferably, the aromatic acid is terephthalic acid. The monomer (A) may also be an aliphatic diacid or a mixture of such diacids. Aliphatic diacid may also be a saturated or unsaturated aliphatic diacid.

The aliphatic diacid may be linear, branched or cyclic. The linear saturated aliphatic diacid can be selected from succinic acid, glutaric acid, adipic acid, pimelic acid, suberic acid, azelaic acid, sebacic acid and mixtures thereof. Preferably, the linear saturated aliphatic diacid is selected from succinic acid, adipic acid and mixtures thereof, most preferentially succinic acid. As a saturated cyclic aliphatic diacid, 1,4-cyclohexanedioic acid can be mentioned.

The monomer (A) can also be an unsaturated aliphatic diacid such as fumaric acid or maleic acid or itaconic acid or a mixture of these diacids.

In the case where the monomer (A) is a diester (or a mixture of diesters), the diester is preferably a methyl and/or ethyl diester. The diester can be selected from the diesters of the previously mentioned diacids. Preferably, the diester is an aromatic diacid diester, preferably a diester of terephthalic acid, isophthalic acid, phthalic acid, 2,6-naphthalene dicarboxylic acid, 1,4-naphthalene dicarboxylic acid, furanedicarboxylic acid, or a mixture of these diesters, most preferentially a diester of terephthalic acid.

According to the invention, a mixture of diacid(s) and diester(s) can also be used as monomers (A).

The monomer (B) is a 1,4:3,6-dianhydrohexitol unit. As explained earlier, 1.4:3,6-dianhydrohexitols have the disadvantage of causing colouring of the polyester when using the monomers and manufacturing methods conventionally used for their manufacture. The 1,4:3,6-dianhydrohexitol may be isosorbide, isomannide, isoidide, or a mixture thereof, and preferably isosorbide. Isosorbide, isomannide and isoidide can be obtained, respectively, by dehydration of sorbitol, mannitol and iditol. Regarding isosorbide, it is sold by the Applicant under the trade name of POLYSORB® P.

Preferably, the monomers introduced into the reactor further comprise a diol (C), different from 1,4:3,6-dianhydrohexitols.

The diol (C) can be:
an aliphatic diol, in particular a linear aliphatic diol (C1), a cycloaliphatic diol (C2), a branched aliphatic diol (C3), or;
an aromatic diol (C4),
or a mixture of these diols.

The diol (C1) is advantageously selected from ethylene glycol, 1,3-propanediol, 1,4-butanediol, 1,5-pentanediol, 1,6-hexanediol, 1,8-octanediol, 1,10-decanediol, or a mixture of these diols, preferentially ethylene glycol, 1,4-butanediol, and a mixture of these diols, very preferentially ethylene glycol.

The diol (C2) may be cyclobutanediol, for example tetramethylcyclobutanediol, bis-hydroxymethyl tricyclodecane or cyclohexanedimethanol, in particular 1,4-cyclohexanedimethanol, 1,2-cyclohexanedimethanol or 1,3-cyclohexanedimethanol, or a mixture of these diols or isomers of these diols. Indeed, these diols can be in cis or trans configuration. When different isomers exist for the same monomer, unless explicitly specified, when referring to this monomer, it can be an isomer of this monomer or a mixture of isomers.

The diol (C3) can be 2-methyl-1,3-propanediol, 2,2,4-trimethyl-1,3-pentanediol, 2-ethyl-2-butyl-1,3-propanediol, propylene glycol, neopentyl glycol or a mixture of these diols.

The diol (C) is advantageously selected from aliphatic diols, preferentially selected from ethylene glycol, 1,3-propanediol, 1,4-butanediol, 1,5-pentanediol, 1,6-hexanediol, 1,8-octanediol, 1,10-decanediol, 1,4-cyclohexanedimethanol, 1,2-cyclohexanedimethanol, 1,3-cyclohexanedimethanol and mixtures of these diols, most preferentially ethylene glycol, 1,4-butanediol, 1,4-cyclohexanedimethanol and mixtures of these diols, most preferably ethylene glycol, 1,4-cyclohexanedimethanol and the mixture of these diols.

According to a first advantageous embodiment wherein the diol (C) is introduced into the reactor, monomer (A) is terephthalic acid, monomer (B) is isosorbide and monomer (C) is ethylene glycol.

According to a second advantageous embodiment wherein the diol (C) is introduced into the reactor, monomer (A) is terephthalic acid, monomer (B) is isosorbide and monomer (C) is a mixture of ethylene glycol and 1,4-cyclohexanedimethanol.

Advantageously, the molar percentage of monomers (A) with respect to the total number of moles of monomers (A), (B) and optionally (C) ranges from to 50%, preferably from 33 to 49%, most preferentially from 40 to 48%.

Preferably, when monomers (C) are introduced into the reactor, the molar percentage of (B), based on the total number of moles of monomers (B) and (C), ranges from 1 to 60%, preferably from 2 to 55%, most preferentially from 5 to 50%.

The monomers (B) and (C) can be introduced into the reactor as an aqueous solution.

Monomers other than monomers (A), (B) and optionally (C), so-called “additional monomers”, can also be added.

They can be hydroxyacid monomers with a hydroxide function and a carboxylic acid function. As an example, the hydroxy acid can be glycolic acid, lactic acid, hydroxybutyric acid, hydroxycaproic acid, hydroxyvaleric acid, 7-hydroxyheptanoic acid, 8-hydroxyoctanoic acid, 9-hydroxynonanoic acid, hydroxymethylfurancarboxylic acid, hydroxybenzoic acid or a mixture of these hydroxy acids. Additional monomers that can be used include dilactones such as glycolide or lactide.

Preferably, the amount of hydroxy acid monomers is, based on the total sum of the monomers, less than 10 mol %. The monomers introduced into the reactor may be free of hydroxy acid monomers.

The additional monomers may also include chain-extending monomers, which are generally introduced into the reactor before or during the formation of the polyester produced in the polymerisation step, or before a second step called the “post-polymerisation step” consisting of reacting the polyester formed in the polymerisation step with the chain-extending monomer. This post-polymerisation step may particularly be a reactive extrusion step of the chain-extending monomer with the polyester recovered after the polymerisation step.

The term “chain-extending monomers” means a monomer comprising two functions other than hydroxyl, carboxylic acid and carboxylic acid ester functions, and capable of reacting with these same functions. The functions may be isocyanate, isocyanurate, lactam, lactone, carbonate, epoxy, oxazoline and imide functions, it being possible for said functions to be identical or different. As chain-extending monomers suitable for use in the present invention, one may mention:
diisocyanates, preferably methylenediphenyl diisocyanate (MDI), isophorone diisocyanate (IPDI), dicyclohexylmethane diisocyanate (H12MDI), toluene diisocyanate (TDI), naphthalene diisocyanate (NDI) hexamethylene diisocyanate (HMDI) or lysine diisocyanate (LDI), aliphatic diisocyanate with a molar mass of 600 g/mol obtained from fatty acid dimers (DDI® 1410 Diisocyanate),
dimers, trimers and tetramers of diisocyanates,
“isocyanate-free” prepolymers resulting from a reaction of a diol or an amine with a diisocyanate under conditions such that the prepolymer contains an isocyanate function at each of its ends (α,ω-functional or telechelic polymer) without free diisocyanate being detectable,
dialkylcarbonates, especially dialkylcarbonates of dianhydrohexitols, and in particular isosorbide dialkylcarbonates,
   dicarbamoylcaprolactams, preferably 1,1′-carbonyl-bis-caprolactam, dicarbamoylcaprolactones,
diepoxides,
compounds containing an epoxide function and a halide function, preferably epichlorohydrin,
heterocyclic compounds, preferably bis-oxazolines, bis-oxazolin-5-ones and bis-azalactones,
methylenic or ethylenic diester derivatives, preferably methyl or ethyl carbonate derivatives,
any mixtures of at least two of the above-mentioned products.

Preferably, the amount of chain-extending monomers is, based on the total sum of the monomers introduced, less than 10 mol %. The monomers introduced into the reactor may be free of chain-extending monomers.

The additional monomers can also be polyfunctional monomers. “Polyfunctional monomers” are monomers that can react with hydroxide and/or carboxylic acid and/or carboxylic acid ester functions and whose functionality is greater than 2. The polyfunctional monomers can be introduced into the reactor prior to the polymerisation or post-polymerisation step as described above (with the polyfunctional monomer replacing the chain-extending monomer), preferentially prior to the polymerisation step. The reactive functions of these branching agents can be hydroxide, carboxylic acid, anhydride, isocyanate, isocyanurate, caprolactam, caprolactone, carbonate, epoxy, oxazoline and imide functions, said functions being able to be identical or different, preferably carboxylic acid, hydroxide, epoxide or isocyanate, most preferentially carboxylic acid or hydroxide. The functionality of these branching agents can be from 3 to 6, preferably from 3 to 4. Among the branching agents trasitionally used are: malic acid, citric or isocitric acid, tartaric acid, trimesic acid, tricarballylic acid, cyclopentane tetracarboxylic acid, trimellitic anhydride, pyromellitic mono- or dianhydride, glycerol, pentaerythritol, dipentaerythritol, monoanhydrosorbitol, monoanhydromannitol, epoxy oils, dihydroxystearic acid, trimethylolpropane, ethers of these polyols, such as, for example, glycerol propoxylate (marketed as Voranol 450 by Dow Chemical), polymers containing lateral epoxide functions, triisocyanates, tetraisocyanates and the respective homopolymers of the existing di-, tri- and tetraisocyanates, polyanhydrides, alkoxysilanes, preferably tetraethoxysilane.

Preferably, the amount of polyfunctional monomers is, based on the total sum of the monomers, less than 10 mol %. The monomers introduced into the reactor may be free of polyfunctional monomers.

Advantageously, with respect to the totality of the monomers introduced into the reactor, the molar quantity of additional monomer is lower than 20%, preferentially lower than 10%, even lower than 5%. The monomers introduced into the reactor may be free of additional monomers.

The method according to the invention further comprises a step of introducing a catalytic system into the reactor, comprising:
either a catalyst comprising the element germanium and a catalyst comprising the element tin;
or a catalyst comprising the elements germanium and tin.

According to the first embodiment, with respect to the catalyst comprising the element germanium, it may be selected from the following compounds: salts of aliphatic carboxylic acids such as formate, acetate, propionate, butyrate, oxalate, acrylate, methacrylate, salts of aromatic carboxylic acids such as benzoate, salts of halogenated carboxylic acids such as trichloracetate trifluoroacetate, hydroxycarbonate salts such as lactate, citrate, oxalate, mineral salts such as carbonate, sulfate, nitrate, phosphate, phosphonate, phosphinate, hydrogen sulfate, hydrogen carbonate, hydrogen phosphate, sulfite, thiosulfate, hydrochloride, hydrobromide, chloride, chlorate, bromide, bromate, organosulfonates such as 1-propane sulfonate, 1-pentane sulfonate, naphthalene sulfonate, organic sulfates such as lauryl sulfate alkoxides such as methoxy, ethoxy, propoxy, iso-propoxy, butoxy, acetylacetonates, oxides, mixed oxides comprising other metals or hydroxides, preferably germanium dioxide.

The catalyst comprising the element tin may be selected from the following compounds: salts of aliphatic carboxylic acids such as formate, acetate, propionate, butyrate, oxalate, acrylate, methacrylate, octoate, salts of aromatic carboxylic acids such as benzoate, salts of halogenated carboxylic acids such as trichloracetate trifluoroacetate, hydroxycarbonate salts such as lactate, citrate, oxalate, mineral salts such as carbonate, sulfate, nitrate, phosphate, phosphonate, phosphinate, hydrogen sulfate, hydrogen carbonate, hydrogen phosphate, sulfite, thiosulfate, hydrochloride, hydrobromide, chloride, chlorate, bromide, bromate, organosulfonates such as 1-propane sulfonate, 1-pentane sulfonate, naphthalene sulfonate, organic sulfates such as lauryl sulfate, mercaptides, alkoxides such as methoxy, ethoxy, propoxy, iso-propoxy, butoxy, acetylacetonates, oxides, mixed oxides comprising other metals or hydroxides, preferably tin (II) oxide or stannous oxide or tin (IV) oxide or stannic oxide.

According to the second embodiment, the catalytic system comprises a catalyst comprising the elements germanium and tin, for example comprises a mixed oxide of germanium and tin.

According to a third embodiment, the catalytic system comprises a mixture of the catalysts described in the previous two embodiments.

The catalytic system can be selected so that the molar elemental ratio Ge:Sn ranges from 1:1 to 5:1, advantageously from 1.5:1 to 5:1, advantageously from 2:1 to 5:1, preferably from 1:1 to 3:1, advantageously from 1.5:1 to 3:1, advantageously from 2:1 to 3:1, preferably from 1:1 to 2.5:1, advantageously from 1.5:1 to 2.5:1, advantageously from 1.75:1 to 2.5:1. Very advantageously, the molar elemental ratio is around 2:1. It is specified that this elemental ratio takes into consideration only the metals included in the catalytic system. According to the examples shown below, it has been observed that the resulting resin is transparent when such a molar elemental ratio is around 2:1, with a molar elemental ratio ranging from 2:1 to 5:1, the resulting resin has a slight yellow colouring.

According to the first and third embodiments, the catalysts may be selected and present in amounts such that the molar elemental ratio Ge:Sn is the one described above.

According to the second embodiment, the catalyst comprising the element germanium and tin is selected such that the molar elemental ratio Ge:

Sn is the one described above.

According to the three embodiments, the amount of the element germanium in the catalytic system varies from 50 to 300 ppm, preferentially from 180 to 220 ppm.

According to the three embodiments, the amount of the tin element in the catalytic system ranges from 10 to 200 ppm, preferentially from 50 to 150 ppm, and even more preferentially from 75 to 125 ppm.

For reasons of simplicity and availability of catalysts, it is preferred to use a catalytic system comprising a catalyst comprising the element germanium and a catalyst comprising the element tin. Advantageously, the total mass quantity of metal included in the catalytic system introduced into the reactor, relative to the total mass quantity of polymer obtained, ranges from 50 to 500 ppm.

The catalytic system can be introduced into the reactor before or during the polymerisation step, preferentially before the polymerisation step. It can be introduced in different stages of introduction, for example by introducing different catalysts at different times. Preferably, when the catalytic system comprises different catalysts, they are introduced simultaneously into the reactor, most preferentially simultaneously and before the polymerisation step. The catalyst(s) can be used as is or in the form of solution(s), especially aqueous or alcoholic, preferably in the form of a solution in a monomer such as ethylene glycol, wherein the catalyst(s) is (are) diluted or dispersed.

In the reaction mixture, the use of a compound comprising the element cobalt makes it possible to obtain polyester compositions with improved b* colouring.

As example compounds comprising the element cobalt, the following compounds may be cited: salts of aliphatic carboxylic acids such as formate, acetate, propionate, butyrate, oxalate, acrylate, methacrylate, salts of aromatic carboxylic acids such as benzoate, salts of halogenated carboxylic acids such as trichloracetate trifluoroacetate, hydroxycarbonate salts such as lactate, citrate, oxalate, mineral salts such as carbonate, sulfate, nitrate, phosphate, phosphonate, phosphinate, hydrogen sulfate, hydrogen carbonate, hydrogen phosphate, sulfite, thiosulfate, hydrochloride, hydrobromide, chloride, chlorate, bromide, bromate, organosulfonates such as 1-propane sulfonate, 1-pentane sulfonate, naphthalene sulfonate, organic sulfates such as lauryl sulfate alkoxides such as methoxy, ethoxy, propoxy, iso-propoxy, butoxy, acetylacetonates, oxides, mixed oxides comprising other metals or hydroxides, preferably cobalt acetate.

The method according to the invention also includes a step of polymerizing the monomers to form the polyester. Advantageously, this polymerisation step is carried out by the melt method, that is by maintaining the reaction medium in the molten state in the reactor, in the absence of solvent. This step of polymerisation can be done by heat supply. This polymerisation step can also be done under vacuum.

Preferably, the monomer polymerisation step comprises:
a first stage during which the reaction medium is stirred at a temperature ranging from 200 to 300° C. in order to form oligomers, advantageously from 245 to 275° C.;
a second stage during which the oligomers formed are stirred under vacuum, at a temperature ranging from 240 to 330° C. so as to form the polyester, advantageously from 255 to 275° C.

The reaction medium can be stirred by any type of stirrer conventionally used for polyester synthesis. The stirring speed can be kept constant during the polymerisation step or the stirring speed can be reduced during the reaction as the viscosity of the polyester increases.

The first stage can be done at atmospheric pressure or under pressure, generally at a pressure ranging from 1.1 to 10 bar.

The oligomers formed in the first stage generally have a number average molar mass below 5000 g/mol, often below 4000 g/mol. They generally have a viscosity index below 20 mL/g.

The monitoring of this first stage can be done by controlling the evolution of the quantity of distillates extracted from the reactor.

The second stage of the polymerisation step is carried out under vacuum, preferably at a pressure of less than 10 mbar, more preferentially less than 1 mbar.

The monitoring of the polymerisation reaction can be done by controlling the change of the amount of torque measured on the stirrer or by any other system that can evaluate the viscosity of the molten reaction medium.

Advantageously, the catalytic system, comprising the catalyst(s) previously described, is introduced into the reactor before the first stage of the polymerisation step.

Preferably, the method comprises a reactor deoxygenation step carried out prior to the monomer polymerisation step, and in particular before the first stage of oligomer formation, advantageously by placing the reactor in an atmosphere of an inert gas such as nitrogen. This deoxygenation step is generally performed at low temperature, that is often at a temperature below 100° C. This can be done by performing at least once a sequence of a vacuum stage, for example between 100 and 700 mbar in the reactor followed by a stage of introducing an inert gas into the reactor, for example between 1.2 and 2 bars. This vacuum-inert gas introduction cycle can be carried out from 3 to 5 times, for example. Preferably, this vacuum-nitrogen cycle is carried out at a temperature of between 60 and 80° C. so that the reagents, and especially the monomers (B), are totally molten. This deoxygenation step has the advantage of further improving the colouring properties of the polyester obtained at the end of the method.

When the reactor is put under vacuum, especially during the second stage of polymerisation of the oligomers, it should be noted that a small part of the monomers can be extracted from the reactor and thus be lost. In particular, a small portion of the more volatile monomers are surplus. This loss of monomers can also lead to a slight loss of catalyst.

Furthermore, so-called “polymerisation additives” can be introduced into the reactor before the polymerisation step.

Among the polymerisation additives, one may mention the anti-oxidants which make it possible to reduce further the colouring of the obtained polyester. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus-based compounds such as Ultranox® 626, Doverphos® S-9228, Hostanox® P-EPQ or Irgafos 168.

It is also possible to introduce, as polymerisation additive into the reactor, at least one compound that is capable of limiting unwanted etherification reactions, such as sodium acetate, tetramethylammonium hydroxide or tetraethylammonium hydroxide.

The method according to the invention further comprises a step of recovering a polyester composition comprising the polyester and the catalytic system. This composition can be recovered by removing it from the reactor in the form of a molten polymer rod. Once cooled, this rod can be converted into granules using conventional granulation techniques.

The polyester obtained after the polycondensation step can, after cooling, be semi-crystalline or amorphous.

The method according to the invention may also comprise, after the step of recovering the polyester composition, a solid state polycondensation (SSP) step. This SSP step can easily be performed by the skilled person from semi-crystalline polyesters.

The invention also relates to the polyester composition, obtainable according to the method of the invention, wherein the polyester contains at least one 1,4:3,6-dianhydrohexitol unit, the composition further comprising either a catalyst comprising the element germanium and a catalyst comprising the element tin, or a catalyst comprising the elements germanium and tin, or a mixture of these catalysts.

The catalytic system included in the polyester composition, is identical to that previously described for the method according to the invention. Thus, in the polyester composition according to the invention, the metals included in the catalytic system may have a molar elemental ratio Ge:Sn which ranges from 1:1 to 5:1, advantageously from 1.5:1 to 3:1, preferably from 1.75:1 to 2.5:1.

The amounts of catalyst in the polyester composition are also close but may be slightly less than those introduced into the reactor, due to the possible catalyst carryover loss described above. However, these losses can be considered relatively small. The total mass amount of metal comprised in the catalytic system of the polyester composition, based on the total mass amount of polyester, typically ranges from 30 to 500 ppm.

The metal content of the catalysts in the polyester can be determined by elemental analysis.

By “monomeric units” is meant according to the invention units included in the polyester which can be obtained after polymerisation of a monomer. For instance, with respect to the ethylene glycol and terephthalic acid units included in a PET, they can either be obtained by an esterification reaction of ethylene glycol and terephthalic acid or by a transesterification reaction of ethylene glycol and terephthalic acid ester.

The polyester included in the composition according to the invention may comprise, based on the total diol units (B) and optionally (C) of the polyester, from 0.1 to 100% of 1,4:3,6-dianhydrohexitol units (100% is the case when no monomer (C) is used in the method), advantageously from 1 to 60%, preferably from 2 to 550%, most preferentially from 5 to 50%.

According to a first very preferred embodiment, the polyester included in the composition comprises, based on the sum of the monomer units:
to 55% terephthalic acid units;
1 to 25% isosorbide;
to 54% ethylene glycol.

According to a second very preferred embodiment, the polyester included in the composition comprises, based on the sum of the monomer units:
to 55% terephthalic acid units;
1 to 25% isosorbide units;
1 to 53% ethylene glycol units;
1 to 53% 1,4-cyclohexanedimethanol units.

The number of diacid units and the number of diol units are generally approximately the same. The ratio of diol units to diacid units comprised in the polyester can range from 1.15:1 to 0.85:1, often from 1.08:1 to 0.92:1.

The amounts of the different units in the polyester can be determined by ¹H NMR.

Those skilled in the art can readily find the analysis conditions for determining the amounts of each of the units of the polyester. For example, from an NMR spectrum of a poly(ethylene-co-isosorbide terephthalate), the chemical shifts relating to the ethylene glycol are between 4.4 and 5.0 ppm, the chemical shifts relating to the terephthalate ring are between 7.8 and 8.4 ppm and the chemical shifts relating to the isosorbide are between 4.1 ppm and 5.8 ppm. The integration of each signal makes it possible to determine the amount of each unit of the polyester.

Preferably, the polyester composition has a clarity L* greater than 45, preferably greater than 55.

In the case where a solid-state polycondensation step is performed, the clarity L* can reach or exceed 65.

Preferably, the polyester composition has a b* colouring between −10 and 10, preferably between −6 and 6. This parameter makes it possible to quantify the colouring going from blue (if b* is negative) to yellow (if b* is positive).

Parameters L* and b* may be determined using a spectrophotometer, via the CIE Lab model.

The polyester composition may have a relative viscosity greater than 35 mL/g, preferably greater than 50 mL/g. The viscosity index can be measured according to the method disclosed in the examples section.

The number average molar mass of the polyester comprised in the polyester composition according to the invention may range from 5000 to 50000 g/mol.

The molar mass of the polyester can be determined by conventional methods, such as by steric exclusion chromatography (SEC) in a mixture of chloroform and 1,1,1,3,3,3-Hexafluoro-2-propanol in a volume ratio of 98:2. Signal detection can then be performed by a differential refractometer calibrated with polymethyl methacrylate standards.

Preferably, the glass transition temperature of the polyester is greater than or equal to 80° C. The glass transition temperature of the polyester may be measured using conventional methods, especially using differential scanning calorimetry (DSC) using a rate of heating of 10 K/min. The experimental protocol is described in detail in the examples section below.

Advantageously, the polyester has a glass transition temperature ranging from 80 to 190° C., preferably from 100 to 170° C., more preferably from 105 to 160° C.

The invention also relates to a composition comprising the polyester according to the invention and at least one additive or at least one additional polymer or at least one mixture thereof.

The polyester composition according to the invention may comprise any polymerisation additives used in the method. It may also comprise other additional additives and/or polymers that are typically added in a subsequent thermomechanical mixing step.

Thus, as example additives, mention may be made of fillers or organic or inorganic fibers, whether on the nanometer scale or not, functionalised or not. These may be silicas, zeolites, glass beads or fibers, clays, mica, titanates, silicates, graphite, calcium carbonate, carbon nanotubes, wood fibers, carbon fibers, polymer fibers, proteins, cellulose fibers, lignocellulosic fibers, and non-destructured granular starch. These fillers or fibers may make it possible to improve the hardness, rigidity or permeability to water or to gases. The composition may comprise from 0.1 to 75% by weight of fillers and/or fibers based on the total weight of the composition, for example from 0.5 to 50%. The additive useful to the composition according to the invention may also comprise opacifying agents, dyes, and pigments. They may be selected from cobalt acetate and the following compounds: HS-325 Sandoplast® RED BB (which is a compound bearing an azo function, also known under the name of Solvent Red 195), HS-510 Sandoplast® Blue 2B, which is an anthraquinone, Polysynthren® Blue R, and Clariant® RSB Violet.

The composition may also include as an additive a processing aid, to decrease the pressure in the processing tool. A release agent to reduce adhesion to polyester forming materials, such as molds or calender rolls, can also be used. These agents can be selected from fatty acid esters and amides, metal salts, soaps, kerosenes or hydrocarbon waxes. Particular examples of these agents are zinc stearate, calcium stearate, aluminum stearate, stearamide, erucamide, behenamide, beeswax or candelilla wax.

The composition according to the invention may also comprise other additives such as stabilizing agents, for example, light stabilizing agents, UV stabilizing agents and thermal stabilizing agents, fluidizing agents, flame retardants and antistatic agents.

The composition may further comprise an additional polymer, different from the polyester according to the invention. This polymer may be selected from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The composition may further comprise as an additional polymer a polymer which makes it possible to improve the impact properties of the polymer, especially functional polyolefins such as functionalised ethylene or propylene polymers and copolymers, core-shell copolymers or block copolymers.

The composition according to the invention may also comprise polymers of natural origin, such as starch, cellulose, chitosans, alginates, proteins such as gluten, pea proteins, casein, collagen, gelatin, lignin, these polymers of natural origin may or may not be physically or chemically modified. Starch can be used in destructured or plasticised form. In the latter case, the plasticiser may be water or a polyol, including glycerol, polyglycerol, isosorbide, sorbitans, sorbitol, mannitol or urea. The method described in WO 2010/010282 A1 can be used to prepare the composition.

The composition according to the invention can be manufactured by conventional thermoplastic processing methods. These conventional methods include at least one step of melt blending or softening the polymers and one step of recovering the composition. This method can be carried out in internal mixers with paddles or rotors, external mixers, single screw, twin screw co-rotating or counter-rotating extruders. However, it is preferred to carry out this mixing by extrusion, using a co-rotating extruder.

The mixing of the components of the composition can be done under inert atmosphere.

In the case of an extruder, the various components of the composition can be introduced by means of introduction hoppers located along the extruder.

The invention also relates to an article comprising the polyester or composition according to the invention.

This article can be of any type and can be obtained by using conventional processing techniques.

This can be, for example, fibers or yarns useful for the textile industry or other industries. These fibers or threads can be woven into fabrics or nonwovens.

The article according to the invention can also be a film or sheet. These films or sheets can be manufactured by calendering, cast film extrusion, and blown film extrusion.

The article according to the invention can also be a container for transporting gases, liquids or/and solids. These can be baby bottles, water bottles, bottles of carbonated and non-carbonated water, juice bottles, soda bottles, bottles of alcoholic beverages, bottles of medicine, bottles of cosmetics, dishes, for example for ready meals, dishes for microwaves or even lids. These containers can be of any size. They can be manufactured by extrusion blow molding, thermoforming or injection blow molding.

These articles can also be optical articles, that is articles requiring good optical properties such as lenses, discs, transparent or translucent panels, optical fibers, films for LCD (Liquid Crystal Display) screens or glass. These optical articles have the advantage of being able to be placed close to light sources and therefore heat, while maintaining excellent dimensional stability and good lightfastness.

The articles may also be multilayer articles, at least one layer of which comprises the polymer or composition according to the invention. These articles can be manufactured by a method comprising a co-extrusion step wherein the materials of the different layers are brought into contact in the molten state. Examples include tube co-extrusion, profile co-extrusion, bottle, vial or tank blowmolding, generally referred to as hollow body blowmolding, film blowing co-extrusion, and cast co-extrusion.

They can also be manufactured by a method comprising a step of applying a layer of polyester in a molten state to a layer of organic polymer, metal or adhesive composition in a solid state. This step can be performed by pressing, overmolding, laminating, extrusion-laminating, coating, extrusion-coating or coating.

The invention also relates to the use of the previously described catalytic system in a polymerisation method to reduce the colouring of a polyester containing at least one 1,4:3,6-dianhydrohexitol unit.

It is clarified that all of the previously described embodiments, which relate to the method and polyester composition according to the invention, are applicable to the use according to the invention.

The invention will now be illustrated in the following examples. It is clarified that these examples do not limit the present invention.

### Methods

The properties of the polymers were studied with the techniques described below:

The reduced viscosity in solution is measured using an Ubbelohde capillary viscometer at 35° C. in orthochlorophenol after dissolving the polymer at 130° C. while stirring. For these measurements, the concentration of the polymer introduced is 5 g/I.

Polymer colour was measured on the pellets using a Konica Minolta CM-2300d spectrophotometer.

The thermal properties of the polyesters were measured by differential scanning calorimetry (DSC): The sample is first heated under a nitrogen atmosphere in an open crucible from 10 to 280° C. (10° C.min-1), cooled to 10° C. (10° C.min-1), then heated again to 320° C. under the same conditions as the first step. The glass transition temperatures were taken at the mid-point of the second heating. Any melting points are determined on the endothermic peak (peak onset) at the first heating. Similarly, the enthalpy of fusion (area under the curve) is determined at the first heating.

For the illustrative examples presented below, the following reagents were used:

Monomers
Monomer (A): Terephthalic acid (purity 99+%) from Accros
Monomer (B): Isosorbide (purity >99.5%) Polysorb ® P from
Roquette Frères
Monomer (C): Ethylene glycol (purity >99.8%) from
Sigma-Aldrich

Catalysts
Germanium dioxide (>99.99%) from Sigma Aldrich
Aluminum triethoxide (>97%) from Sigma Aldrich
Dimethyl tin oxide from SIGMA, CAS No.: 2273-45-2
Dibutyl tin oxide CAS No.: 818-08-6
Molybdenum trioxide (>99.5%) from Sigma Aldrich
Cobalt acetate tetrahydrate (99.999%) from Sigma Aldrich

Polymerisation additives
Irganox ® 195 from BASF SE: Antioxidant
Irganox 1010 from BASF SE: Antioxidant
Hostanox PEPQ from Clariant: Antioxidant
ADK PEP-8: Antioxidant
Phosphoric acid (99.999+%) from Sigma Aldrich: Antioxidant
Sodium acetate trihydrate (purity >99.0%): polymerisation
additive limiting etherification reactions
Tetraethylammonium hydroxide in 80% solution in water from
Sigma Aldrich: Polymerisation additive limiting etherification
reactions

### EXAMPLES

Preparing the Polyesters

### Example 1

To a 2 L reactor are added 3.481 mol ethylene glycol and 1.958 mol isosorbide, 695 g (4.183 mol) terephthalic acid, 0.28 g tetraethylammonium hydroxide (80% solution in water), 0.36 g Irganox 1010, 0.36 g ADK PEP-8, 0.073 g cobalt acetate as pigment, 65 mg dimethyl tin oxide (i.e. 50 ppm) as catalytic agent and 22 mg GeO₂ germanium oxide (i.e. 200 ppm) as catalytic agent.

To extract the residual oxygen from the isosorbide crystals, 4 vacuum-nitrogen cycles are performed between 60 and 80° C. The reaction mixture is then heated to 250° C. (4° C./min) under 2.5 bar of pressure and with constant stirring (150 rpm). The degree of esterification is estimated based on the amount of distillate collected.

Then, the pressure was reduced to 0.7 mbar in 90 minutes and the temperature brought to 265° C. These low pressure conditions were maintained for 150 minutes and the change in polymer viscosity was measured from the torque applied to the stirrer. Finally, a PEIT polymer rod is poured through the bottom valve of the reactor, cooled in a thermo-regulated water tank and cut into pellets of about 500 g. Using such a method avoids contact between the heated polymer and oxygen, so as to reduce colouring and thermo-oxidative degradation.

The properties of the resulting poly(ethylene-co-isosorbide) terephthalate resin are shown in Table 1 below.

### Example 2

To a 2 L reactor are added 1.956 mol ethylene glycol and 1.956 mol isosorbide, 500 g (3.010 mol) terephthalic acid, 0.28 g tetraethylammonium hydroxide (80% solution in water), 0.36 g Irganox 1010, 0.36 g ADK PEP-8, 0.073 g cobalt acetate as pigment, 98 mg dimethyl tin oxide (i.e. 100 ppm) as catalytic agent and 416 mg GeO₂ germanium dioxide (i.e. 200 ppm) as a catalytic agent.

Identical synthetic conditions were used to obtain the poly(ethylene-co-isosorbide) terephthalate resin whose properties are shown in Table 1 below.

### Example 3

To a 2 L reactor are added 5.439 mol ethylene glycol and isosorbide, 3.010 mol terephthalic acid, 0.28 g tetraethylammonium hydroxide (80% solution in water), 0.36 g Irganox 1010, 0.36 g ADK PEP-8, 0.073 g cobalt acetate as pigment, 98 mg tin oxide (ii), also known as stannous oxide (i.e. 100 ppm) as catalytic agent and 416 mg GeO₂ germanium dioxide (i.e. 200 ppm) as a catalytic agent.

The resulting resin has an isosorbide incorporation rate relative to the total amount of diols of 31.8 mol %. The curing time (condensation) is 198 minutes. The viscosity index is 41 mL/g. The glass transition temperature Tg is 113° C. The final color of the polymer is pale yellow with the following characteristics L*=61.4, a*=0.1 and b*=5.4.

### Example 4

To a 30 L reactor are added 4826 g (77,751 mol) ethylene glycol and 6818 g (28,873 mol) isosorbide, 15900 g (95.707 mol) terephthalic acid, 6.41 g tetraethylammonium hydroxide (80% solution in water), 8.23 g Irganox 1010, 8.23 g ADK PEP-8, 0.073 g cobalt acetate as pigment, 2.97 g dimethyl tin oxide (i.e. 100 ppm) as catalytic agent and 6.13 g GeO₂ germanium dioxide (i.e. 200 ppm) as a catalytic agent.

Identical synthetic conditions were used to obtain the poly(ethylene-co-isosorbide) terephthalate resin.

Moreover, the satisfactory results shown by these resins obtained in a 30 L reactor are an indication of the success in scaling up the method.

### Comparative Example 5

To a 2 L reactor are added 3.481 mol ethylene glycol and 1.958 mol isosorbide, 695 g (4.183 mol) terephthalic acid, 0.28 g tetraethylammonium hydroxide (80% solution in water), 0.36 g Irganox 1010, 0.36 g ADK PEP-8, 0.073 g cobalt acetate as a pigment, and 416 mg GeO₂ germanium dioxide (i.e. 300 ppm) as a catalytic agent.

Identical synthetic conditions were used to obtain the poly(ethylene-co-isosorbide) terephthalate resin whose properties are shown in Table 1 below.

### Comparative Example 6

To a 7 L reactor are added 893 g (14.386 mol) ethylene glycol and 701 g (2.968 mol) isosorbide, 2656 g (15.987 mol) terephthalic acid, 0.1825 g sodium acetate tetrahydrate, 0.7070 g Irgamod 195 and 1.2020 g dibutyl tin oxide (i.e., 200 ppm) as a catalytic agent.

Identical synthetic conditions were used to obtain the poly(ethylene-co-isosorbide) terephthalate resin whose properties are shown in Table 1 below.

### Comparative Example 7

To a 7 L reactor are added 893 g (14.386 mol) of ethylene glycol and 701 g (2.968 mol) of isosorbide, 2656 g (15.987 mol) of terephthalic acid, 0.1825 g of sodium acetate tetrahydrate, 0.7070 g of Irgamod 195, 0.9820 g of GeO₂ germanium dioxide (i.e. 300 ppm) as catalytic agent and 3.0445 g of aluminum triethoxide (i.e. 150 ppm) as catalytic agent.

Identical synthetic conditions were used to obtain the poly(ethylene-co-isosorbide) terephthalate resin whose properties are shown in Table 1 below.

Table 1 summarises the manufacturing tests for poly(ethylene-co-isosorbide) terephthalate and the results for viscosity and colour.

TABLE 1

| | % isosorbide | | | | | | | | | | | |
|---|---|---|---|---|---|---|---|---|---|---|---|---|
| | relative to | Catalytic system | | | | t_{poly.} | IV | Tg | Colour | | | |
| | diols | M1 (ppm) | | M2 (ppm) | | (min) | (mL/g) | (° C.) | | L* | a* | b* |
| Ex1 | 29.8 | Ge | 200 | Sn | 50 | 245 | 33.7 | 111 | Pale | 64.1 | 0.05 | 3.41 |
| | | | | | | | | | yellow | | | |
| Ex2 | 29.4 | Ge | 200 | Sn | 75 | 244 | 44.1 | 112 | Yellow | 54 | 1.57 | 7.14 |
| Ex4 | 31.8 | Ge | 200 | Sn | 100 | 198 | 41 | 113 | Colourless | 61.4 | 0.1 | 5.4 |
| CEx5 | 32.4 | Ge | 300 | — | — | 220 | 27.3 | 111 | Dark | 66.9 | 0.2 | 4.85 |
| | | | | | | | | | yellow | | | |
| CEx6 | 19.8 | Sn | 200 | — | — | 176 | 45.6 | 101 | Brown | 51.2 | 3.28 | 12.85 |
| CEx7 | 20.1 | Ge | 200 | A1 | 150 | 213 | 43.4 | 99 | Pale | 59.8 | −0.1 | 8.6 |
| | | | | | | | | | yellow | | | |

Colouring

The examples show that the use of the Ge/Sn catalyst mixture significantly reduces the colouring of the final polymer. This is notable when comparing the tests Ex1 to Ex3 conducted in the presence of a Ge/Sn catalytic mixture with the CEx5 and CEx6 tests conducted in the presence of either Ge alone or Sn alone.

Moreover, it is all the more remarkable that the polymers according to the examples of the invention Ex1 and Ex3 have an incorporation rate of 30 mol % of isosorbide with respect to the diols, whereas the polymers according to the comparative examples CEx5 and CEx6 have only 20 mol %.

Example 2 is also very remarkable with polymers having a molar isosorbide incorporation rate close to 40%, colorless and having a higher viscosity index than the comparative example CEx4.

The comparative test CEx4, wherein the catalytic system comprises only germanium, leads to polymers which also have a low colouring, but have a much lower viscosity index than the examples according to the invention Ex 1 and Ex 3. However, a polymer with a viscosity index as low as that obtained in the CEx4 comparison test does not allow for processability.

Therefore, the example according to the invention Ex3 is remarkable because it combines good physical properties (viscosity index) and good colouring (pale yellow).

The CEx6 test corresponds to Example 4 of international patent application WO2016/066956. It shows that the use of germanium in combination with a metal different from tin, in this case aluminum, does not make it possible to obtain a colorless polymer either, but a polymer with a weak colouring.

Incorporation Rate of the Isosorbide Unit in the Final Polymer Compared to the Diols

In conclusion, under equivalent preparation conditions, the resins according to the invention have a reduced, even transparent colouring and a much higher molar incorporation rate of isosorbide than the polymers obtained in the presence of other known catalytic systems presented in the context of the present disclosure, while retaining a good capacity to be transformable.

Catalytic Activity

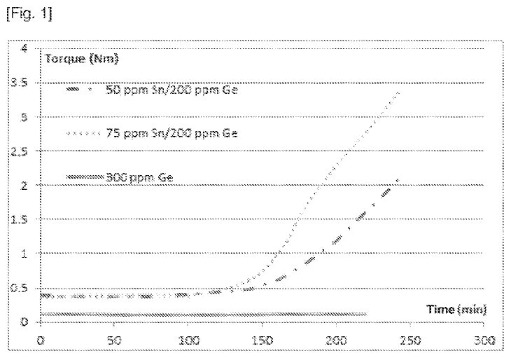

FIG. 1 shows a graph illustrating the variation of the driving torque as a function of the polycondensation time during the synthesis of a PEIT in the presence of different catalytic systems.

This graph clearly demonstrates the improved catalytic activity by the addition of tin as opposed to germanium alone. As previously explained, the monitoring of the polymerisation reaction is done by controlling the change in the amount of torque measured on the stirrer. In other words, the catalytic activity is translated on the graph by the rise of the engine torque according to the polycondensation time.

In fact, in the presence of germanium alone, even after more than 200 minutes, the torque value does not increase. This indicates an absence of viscosity increase, and therefore of polymer production.

The addition of tin to the catalytic system in a Ge/Sn molar ratio equal to 4 results in an exponential increase in the torque observed after about 150 minutes. As said Ge/Sn molar ratio decreases, such an exponential increase in torque is observed after about 125 minutes.

1. A method for manufacturing a polyester containing at least one 1,4:3,6-dianhydrohexitol unit comprising at least:
a step of introducing, into a reactor, monomers comprising at least one monomer (A) which is a diacid or a diester and at least one monomer (B) which is a 1,4:3,6-dianhydrohexitol unit;
a step of introducing into the reactor a catalytic system comprising either a catalyst comprising the element germanium and a catalyst comprising the element tin, or a catalyst comprising the elements germanium and tin, or a mixture of these catalysts;
a step of polymerizing said monomers to form the polyester;
a step of recovering a polyester composition comprising the polyester and the catalytic system.

2. The manufacturing method according to claim 1, wherein a monomer (A) is an aromatic monomer, preferentially selected from terephthalic acid, isophthalic acid, phthalic acid, 2,6-naphthalene dicarboxylic acid, 1,4-naphthalene dicarboxylic acid, a furanedicarboxylic acid, a mixture of these dibasic acids, a dibasic ester of these dibasic acids, and a mixture of these diesters.

3. The manufacturing method according to claim 2, wherein the monomer (A) is terephthalic acid or a terephthalic acid diester.

4. The manufacturing method according claim 1, wherein said monomers further comprise at least one diol (C), different from 1,4:3,6-dianhydrohexitols, in particular a diol selected from aliphatic diols, preferentially selected from ethylene glycol, 1,3-propanediol, 1,4-butanediol, 1,5-pentanediol, 1,6-hexanediol, 1,8-octanediol, 1,10-decanediol, 1,4-cyclohexanedimethanol, 1,2-cyclohexanedimethanol 1,3-cyclohexanedimethanol and mixtures of these diols, most preferentially ethylene glycol, 1,4-butanediol, 1,4-cyclohexanedimethanol and mixtures of these diols, most preferably ethylene glycol, 1,4-cyclohexanedimethanol and the mixture of these diols.

5. The manufacturing method according to claim 1, wherein the polymerisation step is selected from:
a first stage during which the reaction medium is stirred at a temperature ranging from 200 to 300° C. in order to form oligomers, advantageously from 245 to 275° C.;
a second stage during which the oligomers formed are stirred under vacuum, at a temperature ranging from 240 to 330° C. so as to form the polyester, advantageously from 255 to 275° C.

6. The method according to claim 1, wherein the catalytic system is introduced into the reactor before the polymerisation step.

7. The manufacturing method according to claim 1, wherein the catalytic system is chosen so that the molar elemental ratio Ge:Sn ranges from 1:1 to 5:1, advantageously from 1.5:1 to 3:1, preferably from 1.75:1 to 2.5:1.

8. The manufacturing method according to claim 1, wherein the reaction mixture comprises a compound comprising the element cobalt as a pigment.

9. The manufacturing method according to claim 1, wherein the total mass amount of metal included in the catalytic system, relative to the total mass amount of polymer obtained, ranges from 50 to 500 ppm.

10. The method according to claim 1, wherein a reactor deoxygenation step is carried out prior to the monomer polymerisation step, advantageously by placing the reactor under an atmosphere of an inert gas such as nitrogen, for example by carrying out at least once a sequence of a vacuum stage in the reactor followed by a stage of introducing an inert gas into the reactor.

11. The method according to claim 1, wherein the molar percentage of monomer (A) with respect to the total number of moles of monomers (A), (B) and optionally (C) ranges from 25 to 50%, preferably from 33 to 49%, most preferentially from 40 to 48%.

12. The method according to claim 1, wherein the 1,4:3,6-dianhydrohexitol unit is isosorbide.

13. An polyester composition comprising:
a polyester containing at least one 1,4:3,6-dianhydrohexitol unit, and
a catalytic system comprising either a catalyst comprising the element germanium and a catalyst comprising the element tin, or a catalyst comprising the elements germanium and tin, or a mixture of these catalysts.

14. The polyester composition according to claim 13, wherein it has a clarity L* greater than 45, preferably greater than 55.

15. The polyester composition according to claim 13, wherein it has a b* colouring between −10 and 10, preferably between −6 and 6.

16. The polyester composition according to claim 13, wherein it has a reduced viscosity of greater than 35 mL/g, preferably greater than 50 mL/g.

17. An article comprising the polyester composition according to claim 13.

18. Use of a catalytic system comprising a catalyst comprising the element germanium and a catalyst comprising the element tin, a catalyst comprising the elements germanium and tin or a mixture of these catalysts to reduce the colouring of a polyester containing at least one 1,4:3,6-dianhydrohexitol unit.
